(19) United States
(12) Patent Application Publication
(10) Pub. No.: US 2020/0082820 A1
(43) Pub. Date: Mar. 12, 2020

(54) VOICE INTERACTION DEVICE, CONTROL METHOD OF VOICE INTERACTION DEVICE, AND NON-TRANSITORY RECORDING MEDIUM STORING PROGRAM

(71) Applicant: TOYOTA JIDOSHA KABUSHIKI KAISHA, Toyota-shi (JP)

(72) Inventor: Ko KOGA, Setagaya-ku (JP)

(73) Assignee: TOYOTA JIDOSHA KABUSHIKI KAISHA, Toyota-shi (JP)

(21) Appl. No.: 16/452,674

(22) Filed: Jun. 26, 2019

(30) Foreign Application Priority Data
Sep. 6, 2018 (JP) 2018-167279

(51) Int. Cl. G10L 15/22; G10L 17/00; G10L 15/18; G06F 3/16

(52) U.S. Cl. CPC G10L 15/22; G10L 17/005; G10L 2015/227; G06F 3/167; G10L 2015/223; G10L 15/1815

(57) ABSTRACT

A voice interaction device includes a processor configured to identify a speaker who issued a voice by acquiring data of the voice from a plurality of speakers. The processor is configured to perform first recognition processing and execution processing when the speaker is a first speaker who is set as a main interaction partner. The processor is configured to perform second recognition processing and determination processing when a voice of a second speaker who is set as a secondary interaction partner among the plurality of speakers is acquired during execution of the interaction with the first speaker. The processor is configured to output a second utterance sentence by voice by generating data of the second utterance sentence that changes the context based on a second utterance content of the second speaker when it is determined that the second utterance content of the second speaker changes the context.

### INCORPORATION BY REFERENCE

The disclosure of Japanese Patent Application No. 2018-167279 filed on Sep. 6, 2018 including the specification, drawings and abstract is incorporated herein by reference in its entirety.

### BACKGROUND

### 1. Technical Field

The present disclosure relates to a voice interaction device, a control method of the voice interaction device, and a non-transitory recording medium storing a program.

### 2. Description of Related Art

Conventionally, a voice interaction device, mounted on a vehicle for interaction with an occupant of the vehicle by voice, has been proposed. For example, Japanese Patent Application Publication No. 2006-189394 (JP 2006-189394 A) discloses a technique in which an agent image reflecting the taste of a speaker is displayed on a monitor for interaction with the speaker via this agent image.

### SUMMARY

According to the technique disclosed in Japanese Patent Application Publication No. 2006-189394 (JP 2006-189394 A), the line of sight, the direction of the face, and the voice of a speaker are detected by image recognition and voice recognition and, based on these detection results, an interaction with the agent image is controlled. However, with this image recognition and voice recognition, it is difficult to accurately know the situation of a scene where the speaker is present. Therefore, according to the technique disclosed in Japanese Patent Application Publication No. 2006-189394 (JP 2006-189394 A), there is a problem that an interaction according to the situation of a scene cannot be performed.

The present disclosure makes it possible to perform an interaction with a speaker according to the situation of the scene.

A first aspect of the present disclosure is a voice interaction device. The voice interaction device is a processor configured to identify a speaker who issued a voice by acquiring data of the voice from a plurality of speakers. The processor is configured to perform first recognition processing and execution processing when the speaker is a first speaker who is set as a main interaction partner. The first recognition processing recognizes a first utterance content from data of a voice of the first speaker. The execution processing executes an interaction with the first speaker by repeating processing in which data of a first utterance sentence is generated according to the first utterance content of the first speaker and the first utterance sentence is output by voice. The processor is configured to perform second recognition processing and determination processing when a voice of a second speaker who is set as a secondary interaction partner among the plurality of speakers is acquired during execution of the interaction with the first speaker. The second recognition processing recognizes a second utterance content from data of the voice of the second speaker. The determination processing determines whether the second utterance content of the second speaker changes a context of the interaction being executed. The processor is configured to generate data of a second utterance sentence that changes the context based on the second utterance content of the second speaker and output a second utterance sentence by voice when a first condition is satisfied. The first condition is a condition that it is determined that the second utterance content of the second speaker changes the context.

With the configuration described above, when the second speaker makes a request to change the context of an interaction being executed with the first speaker, the context of the interaction being executed can be changed based on the utterance content of the second speaker.

In the voice interaction device, the processor may be configured to generate data of a third utterance sentence according to contents of a predetermined request and to output the third utterance sentence by voice when the first condition and a second condition are both satisfied. The second condition may be a condition that the second utterance content of the second speaker indicates the predetermined request to the first speaker.

With the configuration described above, when the second speaker makes a predetermined request to the first speaker, the data of the third utterance sentence according to the contents of the request can be generated and then output by voice to the first speaker.

In the voice interaction device, the processor may be configured to change a subject of the interaction with the first speaker when the first condition and a third condition are both satisfied. The third condition may be a condition that the second utterance content of the second speaker is an instruction to change the subject of the interaction with the first speaker.

With the configuration described above, when the second speaker makes a request to change the subject of the interaction being executed with the first speaker, the subject of the interaction being executed can be changed.

In the voice interaction device, the processor may be configured to change a volume of the output by voice when the first condition and a fourth condition are both satisfied. The fourth condition may be a condition that the utterance content of the second speaker is an instruction to change the volume of the output by voice.

With the configuration described above, the volume of the output by voice in the interaction being executed can be changed when the second speaker makes a request to change the volume of the output by voice in the interaction being executed with the first speaker.

In the voice interaction device, the processor may be configured to change a time of the output by voice when the first condition and a fifth condition are both satisfied. The fifth condition may be a condition that the second utterance content of the second speaker is an instruction to change the time of the output by voice.

With the configuration described above, the time of the output by voice in the interaction being executed can be changed when the second speaker makes a request to change the time of the output by voice in the interaction being executed with the first speaker.

In the voice interaction device, the processor may be configured to recognize a tone of the second speaker from the data of the voice of the second speaker when the first condition is satisfied and then to output data of a fourth utterance sentence by voice in accordance with the tone.

With the configuration described above, it becomes easier for the first speaker to realize the intention of the second utterance content, issued by the second speaker, by changing the tone in accordance with the tone of the second speaker when the data of a fourth utterance sentence is output by voice.

A second aspect of the present disclosure is a control method of a voice interaction device. The voice interaction device includes a processor. The control method includes: identifying, by the processor, a speaker who issued a voice by acquiring data of the voice from a plurality of speakers; performing, by the processor, first recognition processing and execution processing when the speaker is a first speaker who is set as a main interaction partner, the first recognition processing recognizing a first utterance content from data of a voice of the first speaker, the execution processing executing an interaction with the first speaker by repeating processing in which data of a first utterance sentence is generated according to the first utterance content of the first speaker and the first utterance sentence is output by voice; performing, by the processor, second recognition processing and determination processing when a voice of a second speaker who is set as a secondary interaction partner among the plurality of speakers is acquired during execution of the interaction with the first speaker, the second recognition processing recognizing a second utterance content from data of the voice of the second speaker, the determination processing determining whether the second utterance content of the second speaker changes a context of the interaction being executed; and generating, by the processor, data of a second utterance sentence that changes the context based on the second utterance content of the second speaker and outputting the second utterance sentence by voice when it is determined that the second utterance content of the second speaker changes the context.

With the configuration described above, when the second speaker makes a request to change the context of an interaction being executed with the first speaker, the context of the interaction being executed can be changed based on the second utterance content of the second speaker.

A third aspect of the present disclosure is a non-transitory recording medium storing a program. The program causes a computer to perform an identification step, an execution step, a determination step, and a voice output step. The identification step is a step for identifying a speaker who issued a voice by acquiring data of the voice from a plurality of speakers. The execution step is a step for performing first recognition processing and execution processing when the speaker is a first speaker who is set as a main interaction partner. The first recognition processing recognizes a first utterance content from data of a voice of the first speaker. The execution processing executes an interaction with the first speaker by repeating processing in which data of a first utterance sentence is generated according to the first utterance content of the first speaker and the first utterance sentence is output by voice. The determination step is a step for performing second recognition processing and determination processing when a voice of a second speaker who is set as a secondary interaction partner among the plurality of speakers is acquired during execution of the interaction with the first speaker. The second recognition processing recognizes a second utterance content from data of the voice of the second speaker. The determination processing determines whether the second utterance content of the second speaker changes a context of the interaction being executed. The voice output step is a step for generating data of a second utterance sentence that changes the context based on the second utterance content of the second speaker and outputting the second utterance sentence by voice when it is determined that the second utterance content of the second speaker changes the context.

With the configuration described above, when the second speaker makes a request to change the context of an interaction being executed with the first speaker, the context of the interaction being executed can be changed based on the second utterance content of the second speaker.

With the configuration described above, the context of an interaction being executed can be changed according to the intention of the second speaker by accepting a request from the second speaker during the execution of an interaction with the first speaker. Therefore, an interaction with the speaker in accordance with the situation of the scene can be performed.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a functional block diagram of a voice interaction device according to an embodiment of the present disclosure;

FIG. 2 is a flowchart showing the flow of a voice interaction control method performed by the voice interaction device according to the embodiment of the present disclosure;

FIG. 3 is a diagram showing an example of an interaction between a speaker and an agent when a speaker is identified during execution of the voice interaction control method by the voice interaction device according to the embodiment of the present disclosure;

FIG. 4 is a diagram showing an example of interactive content used during the execution of the voice interaction control method by the voice interaction device according to the embodiment of the present disclosure;

FIG. 5 is a diagram showing an example of interactive content according to the taste of a first speaker used during the execution of the voice interaction control method by the voice interaction device according to the embodiment of the present disclosure;

FIG. 6 is a flowchart showing the procedure of intervention control when the intervention content of a second speaker is an instruction to change interactive content during the execution of the voice interaction control method by the voice interaction device according to the embodiment of the present disclosure;

FIG. 7 is a diagram showing an example of an interaction between the agent and each speaker when the intervention content of a second speaker is an instruction to change interactive content during the execution of the voice interaction control method by the voice interaction device according to the embodiment of the present disclosure;

FIG. 8 is a flowchart showing the procedure of intervention control when the intervention content of a second speaker is an instruction to change the volume of interactive content during the execution of the voice interaction control method by the voice interaction device according to the embodiment of the present disclosure;

FIG. 9 is a diagram showing an example of an interaction between the agent and a second speaker when the intervention content of the second speaker is an instruction to change the volume of interactive content during the execution of the voice interaction control method by the voice interaction device according to the embodiment of the present disclosure;

FIG. 10 is a flowchart showing the procedure of intervention control when the intervention content of a second speaker is an instruction to change the speaking time in interactive content during the execution of the voice interaction control method by the voice interaction device according to the embodiment of the present disclosure;

FIG. 11 is a diagram showing an example of an interaction between the agent and a second speaker when the intervention content of the second speaker is an instruction to change the speaking time in interactive content during the execution of the voice interaction control method by the voice interaction device according to the embodiment of the present disclosure;

FIG. 12 is a flowchart showing the procedure of intervention control when the intervention content of a second speaker is the arbitration of a quarrel during the execution of the voice interaction control method by the voice interaction device according to the embodiment of the present disclosure;

FIG. 13 is a diagram showing an example of an interaction between the agent and each speaker when the intervention content of a second speaker is the arbitration of a quarrel during the execution of the voice interaction control method by the voice interaction device according to the embodiment of the present disclosure;

FIG. 14 is a diagram showing an example of an interaction between the agent and each speaker when the intervention content of a second speaker is the arbitration of a quarrel during the execution of the voice interaction control method by the voice interaction device according to the embodiment of the present disclosure; and

FIG. 15 is a diagram showing an example of an interaction between the agent and each speaker when the intervention content of a second speaker is the arbitration of a quarrel during the execution of the voice interaction control method by the voice interaction device according to the embodiment of the present disclosure.

### DETAILED DESCRIPTION OF EMBODIMENTS

A voice interaction device, a control method of the voice interaction device, and a non-transitory recording medium storing a program according to an embodiment of the present disclosure will be described below with reference to the drawings. Note that the present disclosure is not limited to the embodiment described below. In addition, the components described in the embodiment include those that can be replaced, or readily replaced, by those skilled in the art or those that are substantially equivalent.

The voice interaction device according to this embodiment is a device installed, for example, in a vehicle for interaction with a plurality of speakers (users) in the vehicle. In one aspect, the voice interaction device is built in a vehicle. In this case, the voice interaction device interacts with a plurality of speakers through a microphone, a speaker, or a monitor provided in the vehicle. In another aspect, the voice interaction device is configured as a small robot separate from a vehicle. In this case, the voice interaction device interacts with a plurality of speakers through a microphone, a speaker, or a monitor provided in the robot.

In this embodiment, an anthropomorphic subject that executes an interaction with a plurality of speakers to implement the function of the voice interaction device is defined as an “agent”. For example, when the voice interaction device is built in a vehicle, the anthropomorphic image of the agent (image data) is displayed on the monitor. The image of this agent, such as a human, an animal, a robot, or an animated character, can be selected according to the taste of the speaker. When the voice interaction device is configured as a small robot, the robot itself functions as the agent.

In this embodiment, a scene in which family members are in a vehicle is assumed. In this scene, three speakers are assumed to interact with the voice interaction device: “driver (for example, father)” who is in the driver's seat, non-child “fellow passenger (for example, mother)” who is in the passenger seat, and “children” who are in the backseat.

In addition, it is assumed that the voice interaction device interacts primarily with the children among the above three types of occupant. In other words, the voice interaction device interacts not with the driver but with the children to reduce the burden on the driver during driving, providing an environment where the driver can concentrate on driving. Therefore, the interactive content (such as “word chain, quiz, song, funny story, scary story”) executed by the voice interaction device are mainly targeted at children. In this embodiment, among the plurality of speakers, the primary interaction partner (children) of the voice interaction device is defined as a “first speaker (first user)”, and the secondary partner of the voice interaction device (driver, passenger) is defined as a “second speaker (second user)”.

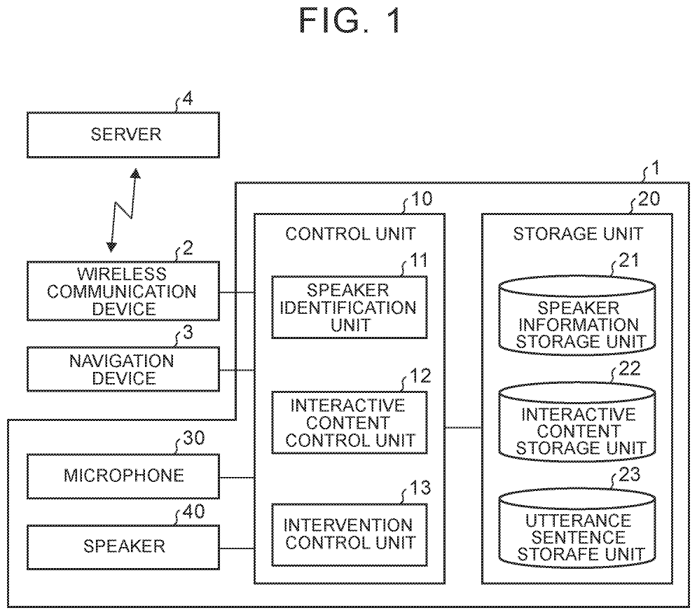

As shown in FIG. 1, a voice interaction device 1 includes a control unit 10, a storage unit 20, a microphone 30, and a speaker 40. In addition, the voice interaction device 1 is connected to a wireless communication device (for example, Data Communication Module (DCM)) 2 and a navigation device 3 via an in-vehicle network such as a Controller Area Network (CAN) in such a way that the voice interaction device 1 can communicate with them.

The wireless communication device 2 is a communication unit for communicating with an external server 4. The wireless communication device 2 and the server 4 are connected, for example, via a wireless network. The navigation device 3 includes a display unit, such as a monitor, and a GPS receiver that receives signals from GPS satellites. The navigation device 3 performs navigation by displaying, on the display unit, the map information around the vehicle and the route information to a destination based on the information on the current position acquired by the GPS receiving unit. The server 4 performs various types of information processing by exchanging information with the vehicle as necessary via the wireless communication device 2.

The control unit (processor) 10, configured more specifically by an arithmetic processing unit such as a Central Processing Unit (CPU), processes voice data received from the microphone 30 and sends the generated utterance sentence data to the speaker 40 for output. The control unit 10 executes computer programs to function as a speaker identification unit 11, an interactive content control unit 12, and an intervention control unit 13.

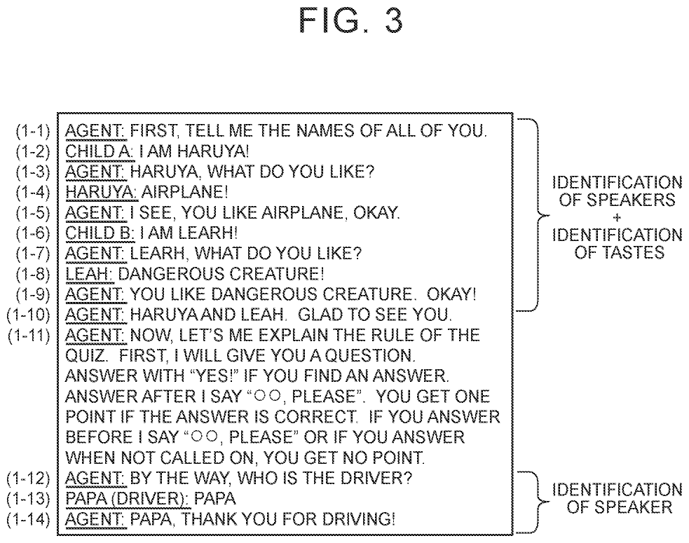

The speaker identification unit 11 acquires voice data on a plurality of speakers in the vehicle from the microphone 30 and, using voice print authentication, identifies a speaker who has issued the voice. More specifically, the speaker identification unit 11 generates the utterance sentence data (in the description below, simply referred to as “utterance sentence”) that asks about the names of a plurality of speakers in the vehicle or an utterance sentence that asks who is the driver and who is the passenger. The speaker identification unit 11 then outputs the generated the utterance sentences by voice through the speaker 40 (for example, see (1-1) and (1-12) in FIG. 3 that will be described later).

Next, from the microphone 30, the speaker identification unit 11 acquires voice data indicating responses from the plurality of speakers and recognizes the acquired utterance content. After that, the speaker identification unit 11 stores the information (hereinafter referred to as “speaker data”), which indicates the association among the speaker's voice, name, and attribute, in a speaker information storage unit 21 that will be described later. When identifying a speaker, the speaker identification unit 11 may ask, for example, about the taste and the age of each speaker and may add the acquired data to the speaker data on each speaker.

The above-described “attribute of a speaker” is the information indicating to which category of a speaker (either the first speaker (child) or the second speaker (driver, passenger)) each speaker belongs. To which category of a speaker (either the first speaker or the second speaker) each speaker belongs can be identified by asking the plurality of speakers in the vehicle about who is the driver and who is the passenger (that is, the second speaker) and then by receiving the responses from them.

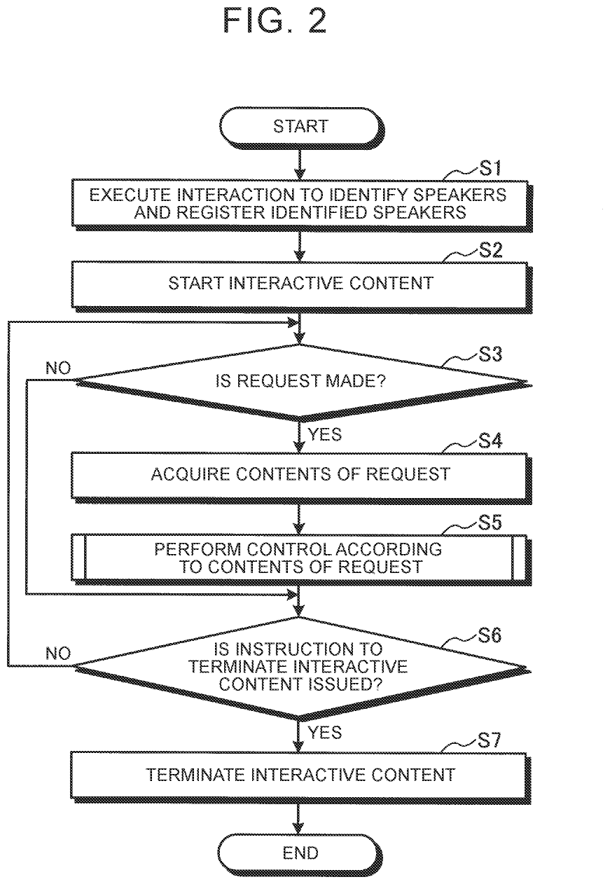

A speaker is identified by the speaker identification unit 11 before the interactive content is started by the interactive content control unit 12 (see FIG. 2 that will be described later). In addition, at least a part of an utterance sentence issued by the agent when the speaker identification unit 11 identifies the speaker (for example, “∘∘, what do you like?” shown in the (1-3) in FIG. 3) is stored in advance in an utterance sentence storage unit 23 that will be described later. The speaker identification unit 11 reads a part of an utterance sentence, necessary for identifying the speaker, from the utterance sentence storage unit 23 and combines the part of the utterance sentence, which has been read, with the name of an interaction partner (for example, “Haruya” in FIG. 3) to generate an utterance sentence (For example, (1-3) in FIG. 3). Then, the speaker identification unit 11 outputs the generated utterance sentence by voice through the speaker 40.

The interactive content control unit 12 interacts with the first speaker (child) who has been set as the main interaction partner. More specifically, when the speaker identified by the speaker identification unit 11 is the first speaker, the interactive content control unit 12 recognizes the utterance content from the voice data of the first speaker acquired via the microphone 30. Then, the interactive content control unit 12 executes an interaction with the first speaker by repeating the processing in which data of the utterance sentence is generated according to the utterance content of the first speaker and the generated utterance sentence is output by voice through the speaker 40.

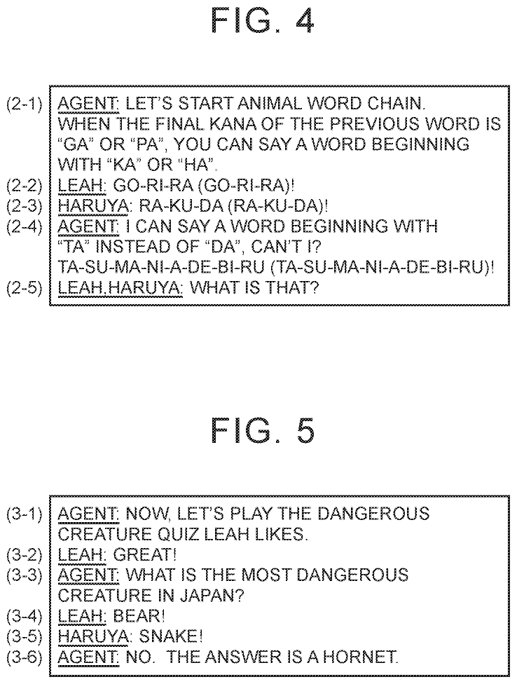

In this embodiment, a set of an utterance sentence related to a certain subject (theme), that is, an utterance sentence actively issued to the first speaker (for example, (2-1) in FIG. 4 that will be described later) and a candidate for an utterance sentence corresponding to a response from the first speaker (for example, (2-4) in FIG. 4), is defined as “interactive content”.

A plurality of subjects, such as “word chain, quiz, song, funny story, scary story”, are set for the interactive content, and a plurality pieces of interactive content each having a theme are stored in advance in an interactive content storage unit 22 that will be described later. The interactive content control unit 12 reads interactive content from the interactive content storage unit 22 and generates an utterance sentence by selecting a necessary utterance sentence or combining the name of an interaction partner with the interactive content. After that, the interactive content control unit 12 outputs the selected or generated utterance sentence by voice.

The intervention control unit 13 changes the context of an interaction being executed, based on the utterance content of the second speaker, when the second speaker makes a request to change the context of the interaction with the first speaker. More specifically, the intervention control unit 13 acquires the voice of the second speaker, who is set as a secondary interaction partner among a plurality of speakers, via the microphone 30 during the execution of an interaction with the first speaker. Next, the intervention control unit 13 recognizes the utterance content from the voice data of the second speaker and determines whether the utterance content of the second speaker will change the context of the interaction being executed. When it is determined that the utterance content of the second speaker will change the context, the intervention control unit 13 generates utterance sentence data that changes the context based on the utterance content of the second speaker and, then, outputs the generated utterance sentence by voice through the speaker 40.

In this embodiment, a request that the second speaker makes to change the context of an interaction with first speaker is defined as an “intervention” as described above. In other words, an intervention by the second speaker means that the information is provided from the second speaker who knows the situation in the scene (inside the vehicle). An intervention by the second speaker is performed during the execution of an interaction with the first speaker when the second speaker wants to (1) change the interactive content to another piece of interactive content, (2) change the volume of the interactive content, (3) change the speaking time of the interactive content, and (4) make a predetermined request to the first speaker. The outline of control performed by the intervention control unit 13 in each of the above-described cases will be described below (in the description below, this control is referred to as “intervention control”).

When the second speaker wants to change interactive content to another piece of interactive content, the intervention control unit 13 performs the first intervention control. When the utterance content of the second speaker acquired during the execution of an interaction with the first speaker is to change the context of the interaction being executed and when the utterance content of the second speaker is an instruction to change the interactive content (for example, (4-1) in FIG. 7 that will be described later), the intervention control unit 13 changes the interactive content to another piece of interactive content. More specifically, “changing the interactive content” indicates that the subject of an interaction with the first speaker is changed.

At least a part of an utterance sentence issued by the agent at the time of the first intervention control is stored in advance in the utterance sentence storage unit 23 that will be described later. For example, the intervention control unit 13 reads a part of an utterance sentence necessary at the time of the first intervention control (for example, “Well, let's play ∘∘ ∘∘ likes, shall we?” indicated by (4-2) in FIG. 7 that will be described later) from the utterance sentence storage unit 23. Then, the intervention control unit 13 combines the part of the utterance sentence, which has been read, with the name of the interaction partner (for example, “Leah” in FIG. 7) and the utterance content of the interaction partner (for example, “dangerous creature quiz” in FIG. 7) to generate an utterance sentence (for example, (4-2) in FIG. 7). After that, the intervention control unit 13 outputs the generated utterance sentence by voice through the speaker 40.

When the second speaker wants to change the volume of interactive content, the intervention control unit 13 performs the second intervention control. When the utterance content of the second speaker acquired during the execution of an interaction with the first speaker is to change the context of the interaction being executed and when the utterance content of the second speaker is an instruction to change the volume of the interactive content (for example, (5-1) in FIG. 9 that will be described later), the intervention control unit 13 changes the volume of the interactive content. More specifically, “changing the volume of the interactive content” indicates that the volume of the voice output by the speaker 40 is changed, that is, the volume of the speaker 40 is changed.

At least a part of an utterance sentence issued by the agent at the time of the second intervention control is stored in advance in the utterance sentence storage unit 23 that will be described later. The intervention control unit 13 reads a part of an utterance sentence necessary at the time of the second intervention control (for example, “Okay. Do you like this volume level, ∘∘?” indicated by (5-2) in FIG. 9 that will be described later) from the utterance sentence storage unit 23. Then, the intervention control unit 13 combines the part of the utterance sentence, which has been read, with the name of the interaction partner (for example, “papa” in FIG. 9) to generate an utterance sentence (for example, (5-2) in FIG. 9). After that, the intervention control unit 13 outputs the generated utterance sentence by voice through the speaker 40.

When the second speaker wants to change the speaking time of interactive content, the intervention control unit 13 performs the third intervention control. When the utterance content of the second speaker acquired during the execution of an interaction with the first speaker is to change the context of the interaction being executed and when the utterance content of the second speaker is an instruction to change the speaking time of the interactive content (for example, (6-1) in FIG. 11 that will be described later), the intervention control unit 13 changes the speaking time. “Changing the speaking time of an interactive content” indicates that the time of voice output by the speaker 40 is changed.

At least a part of an utterance sentence issued by the agent at the time of the third intervention control is stored in advance in the utterance sentence storage unit 23 that will be described later. The intervention control unit 13 reads a part of an utterance sentence necessary at the time of the third intervention control (for example, “Okay. ∘∘. I will not talk around ∘∘” indicated by (6-2) in FIG. 11 that will be described later) from the utterance sentence storage unit 23. Then, the intervention control unit 13 combines the part of the utterance sentence, which has been read, with the name of the interaction partner (for example, “papa” in FIG. 11) and the utterance content of the interaction partner (for example, “intersection” in FIG. 11) to generate an utterance sentence (for example, (6-2) in FIG. 11). After that, the intervention control unit 13 outputs the generated utterance sentence by voice through the speaker 40.

When the second speaker wants to make a predetermined request to the first speaker, the intervention control unit 13 performs the fourth intervention control. When the utterance content of the second speaker acquired during the execution of an interaction with the first speaker is to change the context of the interaction being executed and when the utterance content of the second speaker is to make a predetermined request to the first speaker (for example, (7-1) in FIG. 13 that will be described later), the intervention control unit 13 generates utterance sentence data according to the contents of the request to be made and outputs the generated utterance sentence data by voice. “When a predetermined request is made to the first speaker” is, for example, when it is necessary to arbitrate a quarrel between children who are the first speaker or when it is necessary to comfort a fussy child.

At least a part of an utterance sentence issued by the agent at the time of the fourth intervention control is stored in advance in the utterance sentence storage unit 23 that will be described later. For example, the intervention control unit 13 reads a part of an utterance sentence necessary at the time of the fourth intervention control (for example, “∘∘, why are you crying?” indicated by (7-2) in FIG. 13 that will be described later) from the utterance sentence storage unit 23. Then, the intervention control unit 13 combines the part of the utterance sentence, which has been read, with the name of the interaction partner (for example, “Leah” in FIG. 13) to generate an utterance sentence (for example, (7-2) in FIG. 13). After that, the intervention control unit 13 outputs the generated utterance sentence by voice through the speaker 40.

The storage unit 20, configured for example by a Hard Disk Drive (HDD), a Read Only Memory (ROM), and a Random access memory (RAM), includes the speaker storage unit 21, the interactive content storage unit 22, and the utterance sentence storage unit 23.

The speaker storage unit 21 stores speaker data generated by the speaker identification unit 11. The interactive content storage unit 22 stores, in advance, a plurality pieces of interactive content to be used by the interactive content control unit 12. For example, the interactive content storage unit 22 stores interactive content having a plurality of subjects (“word chain, quiz, song, funny story, scary story”, etc.) in which a child who is the first speaker is interested. The utterance sentence storage unit 23 stores, in advance, a part of an utterance sentence to be generated by the speaker identification unit 11, the interactive content control unit 12 and the intervention control unit 13.

The microphone 30 collects voices produced by a plurality of speakers (first speaker: child, second speaker: driver, passenger) and generates voice data. After that, the microphone 30 outputs the generated voice data to each unit of the control unit 10. The speaker 40 receives utterance sentence data generated by each unit of the control unit 10. After that, the speaker 40 outputs the received utterance sentence data to a plurality of speakers (first speaker: child, second speaker: driver, passenger) by voice.

The microphone 30 and the speaker 40 are provided in the vehicle when the voice interaction device 1 is built in a vehicle, and in the robot when the voice interaction device 1 is configured by a small robot.

The voice interaction control method performed by the voice interaction device 1 will be described below with reference to FIG. 2 to FIG. 5.

When the agent of the voice interaction device 1 is activated (start), the speaker identification unit 11 executes an interaction to identify a plurality of speakers (first speaker and second speaker) in the vehicle and registers the identified speakers (step S1).

In step S1, the speaker identification unit 11 interacts with two children A and B, who are first speakers, to identify their names (Haruya, Leah) and stores the identified names in the speaker storage unit 21 as speaker data, for example, as shown in (1-1) to (1-9) in FIG. 3. In this step, the speaker identification unit 11 interacts also with the driver (papa), who is the second speaker, to identify the driver and stores the information about him in the speaker storage unit 21 as the speaker data as shown in (1-12) to (1-14) in FIG. 3).

In step S1, the speaker identification unit 11 may collect information about the names as well as about the tastes of children A and B, as shown in (1-3) to (1-5) and (1-7) to (1-9) in FIG. 3. The speaker identification unit 11 may include the collected taste information in the speaker data for storage in the speaker storage unit 21. The information about the tastes, collected in this step, is referenced when the interactive content control unit 12 selects interactive content as will be described later (see FIG. 5 that will be described later).

Next, the interactive content control unit 12 starts interactive content for the children A and B (step S2). In this step, the interactive content control unit 12 reads interactive content, such as “word chain” shown in FIG. 4 or “Quiz” shown in FIG. 5, from the interactive content storage unit 22 and executes an interaction. FIG. 5 shows an example in which the interactive content control unit 12 selects interactive content (dangerous creature quiz) that matches the taste of the speaker (child B: Leah), who has been identified during speaker identification, from the interactive content stored in the interactive content storage unit 22.

Next, the intervention control unit 13 determines whether the second speaker makes a request to change the context of the interaction during the execution of the interaction with the first speaker (step S3). When it is determined in step S3 that such a request is made (Yes in step S3), the intervention control unit 13 acquires the contents of the request from the voice data of the second speaker (step S4) and performs control according to the contents of the request (step S5). When it is determined in step S3 that no such request is made (No in step S3), the processing of the intervention control unit 13 proceeds to step S6.

Following step S5, the interactive content control unit 12 determines, based on the voice data of the second speaker, whether an instruction to terminate the interactive content is issued by the second speaker (step S6). When it is determined in step S6 that an instruction to terminate the interactive content is issued by the second speaker (Yes in step S6), the interactive content control unit 12 terminates the interactive content (step S7). Thus, the voice interaction control is terminated. When it is determined in step S6 that no instruction to terminate the interactive content is issued by the second speaker (No in step S6), the processing of the interactive content control unit 12 returns to step S3.

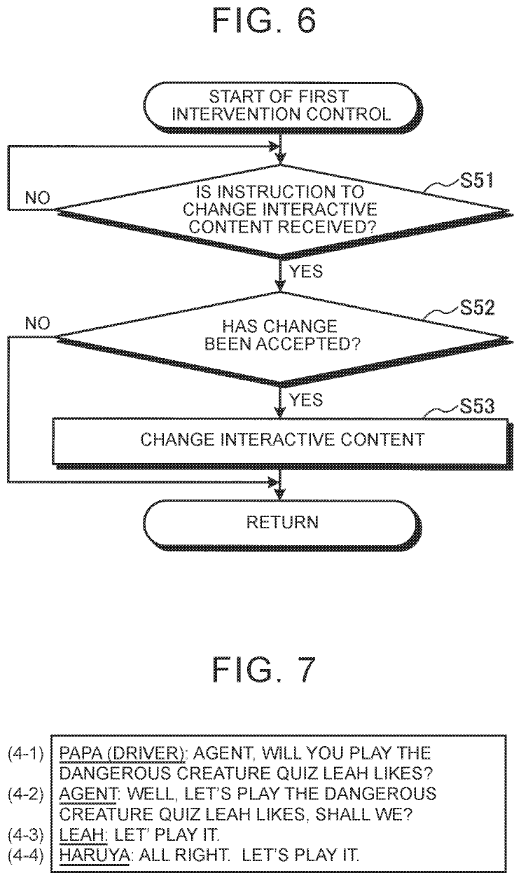

An example of intervention control in step S5 in FIG. 2 will be described below with reference to FIG. 6 to FIG. 15. Examples of the first to fourth intervention control, performed by the intervention control unit 13 in step S5, will be described below.

The first intervention control will be described. For example, while an interaction of interactive content (for example, “word chain”) with the children sitting in the back seat is executed, the children may get bored when the voice interaction device 1 executes the interaction using only the interactive content of the same subject. However, there is no way for the voice interaction device 1 to know the situation of such a scene. To address this problem, the intervention control unit 13 performs the first intervention control. In the first intervention control, the intervention control unit 13 accepts an intervention from the driver (or the passenger), who knows the situation of the scene, to change the interactive content, thus avoiding the situation in which the children get bored with the interactive content.

In this case, as shown in FIG. 6, the intervention control unit 13 determines whether an instruction to change the interactive content is received from the second speaker, based on the contents of the request acquired in step S4 described above (step S51). When it is determined in step S51 that an instruction to change the interactive content is received from the second speaker (Yes in step S51), the intervention control unit 13 determine whether the first speaker has accepted the change of the interactive content, based on the utterance content of the first speaker (step S52). When it is determined in step S51 that an instruction to change the interactive content is not received from the second speaker (No in step S51), the processing of the intervention control unit 13 returns to step S51.

When it is determined in step S52 that the first speaker has accepted the change of the interactive content (Yes in step S52), the intervention control unit 13 changes the interactive content to another piece of interactive content according to the change instruction (step S53). Then, the first intervention control is terminated. When it is determined in step S52 that the first speaker has not accepted the change of the interactive content (No in step S52), the intervention control unit 13 terminates the first intervention control.

For example, in the first intervention control, an interaction such as the one shown in FIG. 7 is executed. First, the driver (papa) instructs the agent to change the interactive content to interactive content (dangerous creature quiz) that the child (Leah) likes ((4-1) in FIG. 7). In response to this instruction, the agent asks the two children (Leah, Haruya) to accept the change of the interactive content ((4-2) in FIG. 7) and, when the two children (Leah and Haruya) have accepted the change ((4-3), (4-4) in FIG. 7), changes the interactive content. In the example shown in FIG. 7, the two children have accepted the change of interactive content. When the two children have not accepted the change, the agent may propose a change to another piece of interactive content.

The second intervention control will be described. For example, when the volume of interactive content (volume of the speaker 40) is too high while the voice interaction device 1 executes an interaction with the first speaker, the driver may not be able to concentrate on driving with the result that the driving may become unstable. However, there is no way for the voice interaction device 1 to know such a situation in the scene. To address this problem, the intervention control unit 13 performs the second intervention control. In the second intervention control, the intervention control unit 13 accepts an intervention from the driver (or the passenger), who knows the situation of the scene, to change the volume of the interactive content, thus preventing the driver's driving from becoming unstable.

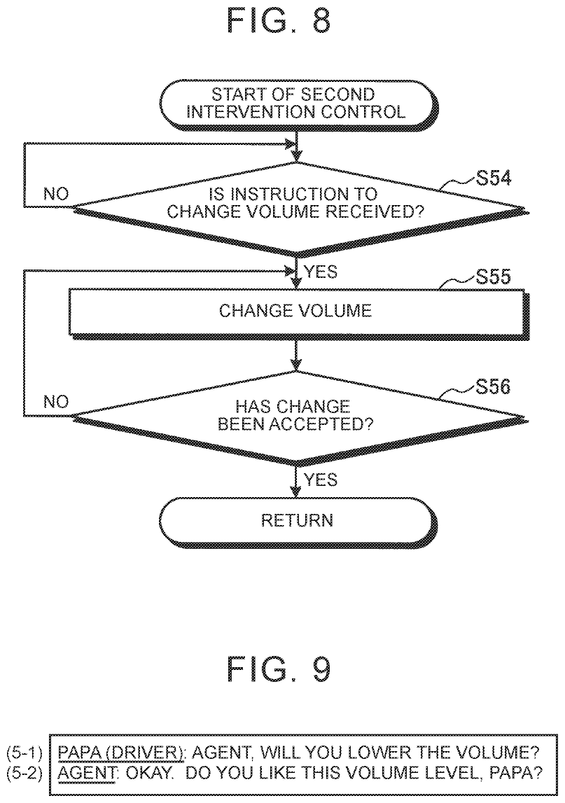

In this case, as shown in FIG. 8, the intervention control unit 13 determines whether an instruction to change the volume of the interactive content is received from the second speaker, based on the contents of the request acquired in step S4 described above (step S54). When it is determined in step S54 that an instruction to change the volume of the interactive content is received from the second speaker (Yes in step S54), the intervention control unit 13 changes the volume of the speaker 40 according to the change instruction (step S55). When it is determined in step S54 that an instruction to change the volume of the interactive content is not received from the second speaker (No in step S54), the processing of the intervention control unit 13 returns to step S54.

Next, the intervention control unit 13 determines whether the second speaker has accepted the change in the volume of the interactive content (step S56). When it is determined in step S56 that the second speaker has accepted the change in the volume of the interactive content (Yes in step S56), the intervention control unit 13 terminates the second intervention control. When it is determined in step S56 that the second speaker has not accepted the change in the volume of the interactive content (No in step S56), the processing of the intervention control unit 13 returns to step S55.

For example, in the second intervention control, the interaction such as the one shown in FIG. 9 is executed. First, the driver (papa) instructs the agent to lower the volume of the interactive content ((5-1) in FIG. 9). In response to this instruction, the agent lowers the volume of the interactive content by a predetermined amount and, then, asks the driver for acceptance ((5-2) in FIG. 9).

The third intervention control will be described. For example, when the sound of an interaction between the voice interaction device 1 and the first speaker is heard in a situation in which careful driving is required, for example, at an intersection or at the entrance/exit of a freeway, the driver may not be able to concentrate on driving with the result that the driving may become unstable. However, there is no way for the voice interaction device 1 to know the situation of such a scene. To address this problem, the intervention control unit 13 performs the third intervention control. In the third intervention control, the intervention control unit 13 accepts an intervention from the driver (or the passenger), who knows the situation of the scene, to change the speaking time of the interactive content, thus preventing the driver's driving from becoming unstable.

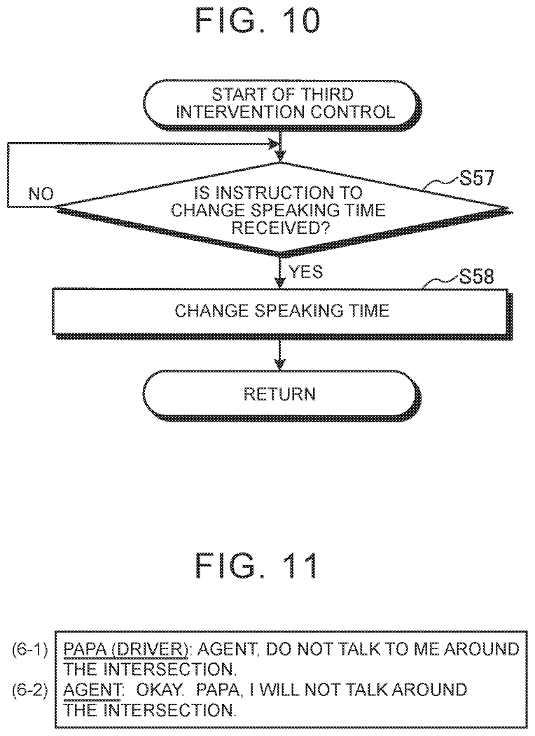

In this case, as shown in FIG. 10, the intervention control unit 13 determines whether an instruction to change the speaking time is received from the second speaker, based on the contents of the request acquired in step S4 described above (step S57). When it is determined in step S57 that an instruction to change the speaking time is received from the second speaker (Yes in step S57), the intervention control unit 13 changes the speaking time of the interactive content (step S58) and terminates the third intervention control. When it is determined in step S57 that an instruction to change the speaking time is not received from the second speaker (No in step S57), the processing of the intervention control unit 13 returns to step S57.

In the third intervention control, an interaction is executed, for example, as shown in FIG. 11. First, the driver (papa) instructs the agent not to speak around an intersection ((6-1) in FIG. 11). In response to this instruction, the agent changes the speaking time in such a way that the agent will not speak around the intersection ((6-2) in FIG. 11). Note that the position of an intersection can be identified by the navigation device 3.

The fourth intervention control will be described. For example, in some cases, the children may start a quarrel during driving. In such a case, the driver may not be able to concentrate on driving with the result that the driving may become unstable. However, there is no way for the voice interaction device 1 to know the situation of such a scene. To address this problem, the intervention control unit 13 performs the fourth intervention control. In the fourth intervention control, the intervention control unit 13 accepts an intervention from the driver (or the passenger), who knows the situation of the scene, to arbitrate the quarrel between the children, thus preventing the driver's driving from becoming unstable.

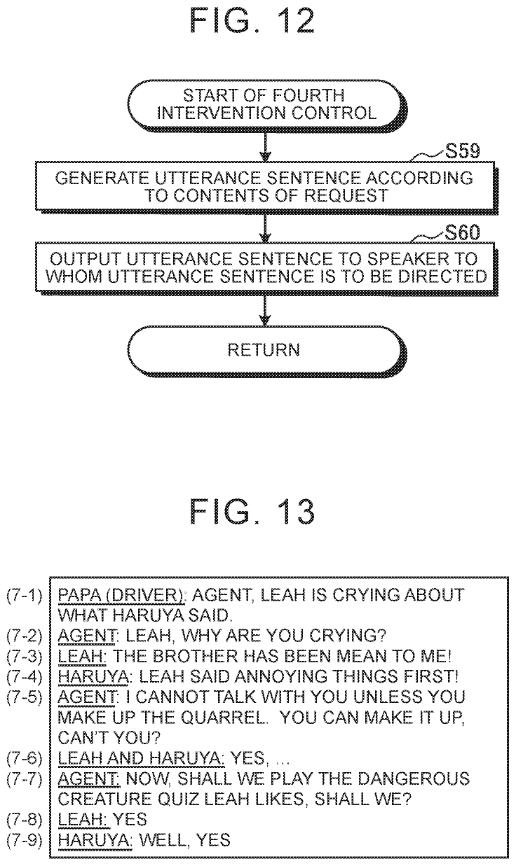

In this case, as shown in FIG. 12, the intervention control unit 13 generates an utterance sentence according to the contents of the request of the second speaker, based on the contents of the request acquired in step S4 described above (step S59). After that, the intervention control unit 13 outputs the generated utterance sentence (output by voice) to the first speaker to whom the utterance sentence is to be directed (step S60).

In the fourth intervention control, an interaction is executed, for example, as shown in FIG. 13. First, the driver (papa) informs the agent about the occurrence of a quarrel between the children ((7-1) in FIG. 13). In response to this information, the agent interrupts the interactive content and arbitrates the quarrel between the two children (Leah and Haruya) ((7-2) to (7-6) in FIG. 13). Then, the agent proposes a change to another piece of interactive content (dangerous creature quiz) that matches the taste of the child (Leah) ((7-2) to (7-7) in FIG. 13).

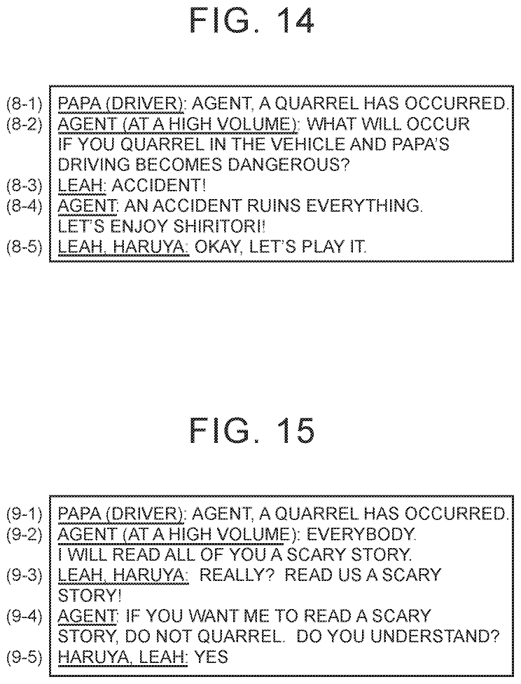

In the fourth intervention control, an interaction may be executed, for example, as shown in FIG. 14. First, the driver (papa) informs the agent about the occurrence of a quarrel between the children ((8-1) in FIG. 14). In response to this information, the agent interrupts the interactive content and speaks to the two children (Leah and Haruya) with a louder voice than usual to arbitrate the quarrel ((8-2) to (8-4) in FIG. 14). Then, the agent proposes a change to another piece of interactive content (word chain) ((8-4) and (8-5) in FIG. 14).

In the fourth intervention control, an interaction may be executed, for example, as shown in FIG. 15. First, the driver (papa) informs the agent about the occurrence of a quarrel between the children ((9-1) in FIG. 15). In response to this information, the agent interrupts the interactive content and proposes to the two children (Leah, Haruya) a change to another piece of interactive content (scary story) with a louder voice than usual ((9-2) in FIG. 15). As a result, the interest of the two children shifts from the quarrel to a scary story without any more quarrel.

Note that, in the fourth intervention control, the intervention control unit 13 may recognize the tone of the second speaker from the voice data of the second speaker (driver and passenger) and output, by voice, generated utterance sentence data in accordance with the recognized tone. The above-mentioned “tone” includes the volume, intonation, and speed of the voice. In this case, when the driver (papa) informs the agent about the occurrence of a quarrel between the children in a scolding tone or with a loud voice, for example, in FIG. 13 to FIG. 15 described above, the intervention control unit 13 causes the agent to output, by voice, the utterance sentence to the children in a scolding tone or with a loud voice.

In this way, by changing the tone in accordance with the tone of the second speaker when an utterance sentence is output by voice, it becomes easier for the first speaker to realize the intention of the utterance content issued by the second speaker. Therefore, the driver's intention is more likely to be reflected, for example, when the agent arbitrates a children's quarrel or comforts a fussy child. This means that it is possible to make an effective request to the children. For example, it is possible to solve children's quarrel sooner or to put the children back into a good humor sooner.

As described above, according to the voice interaction device 1 and the voice interaction method using the device in this embodiment, a request can be accepted from the second speaker (driver, passenger) during the execution of an interaction with the first speaker (children). By doing so, since the context of an interaction being executed can be changed according to the intention of the second speaker, it is possible to execute the interaction with the speaker in accordance with the situation of the scene.

In addition, according to the voice interaction device 1 and the voice interaction method using the device, an intervention from the driver (or passenger) may be accepted when a situation that cannot be identified through sensing occurs (for example, when a quarrel occurs between children, or a child becomes fussy, in the vehicle). Accepting an intervention in this way makes it possible to arbitrate a quarrel between children or to comfort a child, thus avoiding a situation in which the driver cannot concentrate on driving and preventing the driver's driving from becoming unstable.

The voice interaction program according to this embodiment causes a computer to function as each component (each unit) of the control unit 10 described above. The voice interaction program may be stored and distributed in a computer readable recording medium, such as a hard disk, a flexible disk, or a CD-ROM, or may be distributed over a network.

While the voice interaction device, the control method of the voice interaction device, and the non-transitory recording medium storing a program have been described using the embodiment that carries out the present disclosure, the spirit of the present disclosure is not limited to these descriptions, and should be broadly interpreted based on the description of claims. Moreover, it is to be understood that various changes and modifications based on these descriptions are included in the spirit of the present disclosure.

For example, although FIG. 1 described above shows an example in which all components of the voice interaction device 1 are mounted on a vehicle, a part of the voice interaction device 1 may be included in the server 4. For example, with all the components of the voice interaction device 1 other than the microphone 30 and the speaker 40 included in the server 4, speaker identification, interactive content control, and intervention control may be performed by communicating with the server 4 through the wireless communication device 2.

Although only the driver is identified as the second speaker in FIG. 3 described above, the passenger may also be identified as the second speaker together with the driver.

In the examples in FIG. 7, FIG. 9, FIG. 11, and FIG. 13 to FIG. 15, the driver makes a request for intervention in the first to fourth intervention control. Instead, the passenger may make a request for intervention in the first to fourth intervention control.

The speaker identification unit 11 of the voice interaction device 1 may distinguish between a child (first speaker) and an adult (second speaker) by asking about the speaker's age at the time of speaker identification.

Although it is assumed in the above embodiment that the voice interaction device 1 is mounted on a vehicle, the voice interaction device 1 may be provided in the home for interaction with the family members in the home.

What is claimed is:

1. A voice interaction device comprising
a processor configured to identify a speaker who issued a voice by acquiring data of the voice from a plurality of speakers,
the processor being configured to perform first recognition processing and execution processing when the speaker is a first speaker who is set as a main interaction partner, the first recognition processing recognizing a first utterance content from data of a voice of the first speaker, the execution processing executing an interaction with the first speaker by repeating processing in which data of a first utterance sentence is generated according to the first utterance content of the first speaker and the first utterance sentence is output by voice,
the processor being configured to perform second recognition processing and determination processing when a voice of a second speaker who is set as a secondary interaction partner among the plurality of speakers is acquired during execution of the interaction with the first speaker, the second recognition processing recognizing a second utterance content from data of the voice of the second speaker, the determination processing determining whether the second utterance content of the second speaker changes a context of the interaction being executed, and
the processor is configured to generate data of a second utterance sentence that changes the context based on the second utterance content of the second speaker and output the second utterance sentence by voice when a first condition is satisfied, the first condition is a condition that it is determined that the second utterance content of the second speaker changes the context.

2. The voice interaction device according to claim 1, wherein
the processor is configured to generate data of a third utterance sentence according to contents of a predetermined request and to output the third utterance sentence by voice when the first condition and a second condition are both satisfied, the second condition is a condition that the second utterance content of the second speaker indicates the predetermined request to the first speaker.

3. The voice interaction device according to claim 1, wherein
the processor is configured to change a subject of the interaction with the first speaker when the first condition and a third condition are both satisfied, the third condition is a condition that the second utterance content of the second speaker is an instruction to change the subject of the interaction with the first speaker.

4. The voice interaction device according to claim 1, wherein
the processor is configured to change a volume of the output by voice when the first condition and a fourth condition are both satisfied, the fourth condition is a condition that the second utterance content of the second speaker is an instruction to change the volume of the output by voice.

5. The voice interaction device according to claim 1, wherein
the processor is configured to change a time of the output by voice when the first condition and a fifth condition are both satisfied, the fifth condition is a condition that the second utterance content of the second speaker is an instruction to change the time of the output by voice.

6. The voice interaction device according to claim 1, wherein
the processor is configured to recognize a tone of the second speaker from the data of the voice of the second speaker when the first condition is satisfied and then to output data of a fourth utterance sentence by voice in accordance with the tone.

7. A control method of a voice interaction device, the voice interaction device including a processor, the control method comprising:
identifying, by the processor, a speaker who issued a voice by acquiring data of the voice from a plurality of speakers;
performing, by the processor, first recognition processing and execution processing when the speaker is a first speaker who is set as a main interaction partner, the first recognition processing recognizing a first utterance content from data of a voice of the first speaker, the execution processing executing an interaction with the first speaker by repeating processing in which data of a first utterance sentence is generated according to the first utterance content of the first speaker and the first utterance sentence is output by voice;
performing, by the processor, second recognition processing and determination processing when a voice of a second speaker who is set as a secondary interaction partner among the plurality of speakers is acquired during execution of the interaction with the first speaker, the second recognition processing recognizing a second utterance content from data of the voice of the second speaker, the determination processing determining whether the second utterance content of the second speaker changes a context of the interaction being executed; and
generating, by the processor, data of a second utterance sentence that changes the context based on the second utterance content of the second speaker and outputting the second utterance sentence by voice by generating data of the second utterance sentence that changes the context based on the second utterance content of the second speaker when it is determined that the second utterance content of the second speaker changes the context.

8. A non-transitory recording medium storing a program, wherein
the program causes a computer to perform an identification step, an execution step, a determination step, and a voice output step,
the identification step is a step for identifying a speaker who issued a voice by acquiring data of the voice from a plurality of speakers,
the execution step is a step for performing first recognition processing and execution processing when the speaker is a first speaker who is set as a main interaction partner, the first recognition processing recognizing a first utterance content from data of a voice of the first speaker, the execution processing executing an interaction with the first speaker by repeating processing in which data of a first utterance sentence is generated according to the first utterance content of the first speaker and the first utterance sentence is output by voice,
the determination step is a step for performing second recognition processing and determination processing when a voice of a second speaker who is set as a secondary interaction partner among the plurality of speakers is acquired during execution of the interaction with the first speaker, the second recognition processing recognizing a second utterance content from data of the voice of the second speaker, the determination processing determining whether the second utterance content of the second speaker changes a context of the interaction being executed, and
the voice output step is a step for generating data of a second utterance sentence that changes the context based on the second utterance content of the second speaker and outputting the second utterance sentence by voice when it is determined that the second utterance content of the second speaker changes the context.
